(19) United States
(12) Patent Application Publication
(10) Pub. No.: US 2023/0075525 A1
(43) Pub. Date: Mar. 9, 2023

(54) POLICY CONTROLLED SHARING OF DATA AND PROGRAMMATIC ASSETS

(71) Applicant: SafeLiShare, Inc., Morristown, NJ (US)

(72) Inventor: Shamim A. Naqvi, Morristown, NJ (US)

(21) Appl. No.: 17/939,314

(22) Filed: Sep. 7, 2022

Related U.S. Application Data
(60) Provisional application No. 63/241,239, filed on Sep. 7, 2021.

(51) Int. Cl. H04L 9/08; H04L 9/14

(52) U.S. Cl. CPC H04L 9/0816; H04L 9/14

(57) ABSTRACT

Secure computing environments are employed to effectuate execution of algorithms to process datasets. For this purpose a secure data pipeline is used in which trusted and isolated computing environments receive and process the algorithms and datasets. A trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate.

### CROSS-REFERENCE TO RELATED APPLICATIONS

This application claims the benefit of U.S. Provisional Application Ser. No. 63/241,239, filed Sep. 7, 2021, the contents of which are incorporated herein by reference.

This application is also related to U.S. Ser. No. 17/714,666, filed Apr. 6, 2022, which claims the benefit of U.S. Provisional Application Ser. No. 63/171,291, filed Apr. 4, 2021, the contents of which are incorporated herein by reference.

### FIELD OF THE INVENTION

The present invention relates generally to protecting data privacy and intellectual property of computer programs with particular emphasis on cases wherein such data or programs are shared between distinct entities such as enterprises and corporations.

### BACKGROUND

Data collection has become ubiquitous and a major activity of enterprises. There are many enterprises whose business model is to collect and monetize data. Some enterprises are engaged in the creation and distribution of computer programs and applications, i.e., programmatic assets.

Owners of datasets and computer programs would understandably like to protect their data from being copied or distributed without authorization. Enterprises which acquire datasets need to provide assurances that they will abide by the policies governing the acquisition of data or execution of computer programs.

When data and programmatic assets are shared, several questions arise pertaining to ownership, usage, intellectual property, rights adhering to the sharing, etc.

Sharing of assets may be further complicated if a shared asset contains private or sensitive data, e.g., a shared dataset may contain Patient Health Information (commonly abbreviated as PHI), or Patient Identity Information (PII).

Therefore, a technology that protects and manages the sharing of assets would be of enormous benefit to commercial activities and members of society.

### SUMMARY

In accordance with one aspect of the methods and systems described herein, a method is provided for securely receiving an algorithm in a computing environment that is to process a dataset. In accordance with the method, an algorithm is received in a first trusted and isolated computing environment for processing datasets that is received in encrypted form from an algorithm-providing computational domain of an entity that is authorized to provide the algorithm. The algorithm is encrypted by a first encryption key. The first trusted and isolated computing environment is established by a controlling trusted and isolated computing environment that provides the algorithm-providing computational domain with a second encryption key for encrypting the first encryption key. A first decryption key for decrypting the first encryption key is received in the first trusted and isolated computing environment from the controlling trusted and isolated computing environment such that the first trusted and isolated computing environment is able to decrypt the encrypted algorithm without allowing any other computational domain to access the algorithm in an unencrypted form except for the algorithm-providing computational domain. A trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate.

In accordance with another aspect of the methods and systems described herein, the first encryption key is a symmetric key.

In accordance with another aspect of the methods and systems described herein, the symmetric key is generated within the algorithm-providing computational domain.

In accordance with another aspect of the methods and systems described herein, the symmetric key is encrypted by the second encryption key within the algorithm-providing computational domain and provided to the controlling trusted and isolated computing environment.

In accordance with another aspect of the methods and systems described herein the method further includes: receiving in the first trusted and isolated computing environment from the controlling trusted and isolated computing environment a decryption key for decrypting the symmetric key; decrypting the encrypted algorithm within the first trusted and isolated computing environment to provide an unencrypted algorithm; re-encrypting the unencrypted algorithm with a second encryption key received from the controlling trusted and isolated computing environment; and storing the re-encrypted algorithm in a storage system external to the first trusted and isolated computing environment.

In accordance with another aspect of the methods and systems described herein, a method of securely processing a dataset with an algorithm to produce an output result to be securely provided to an output recipient includes: establishing, with a controlling trusted and isolated computing environment, a first trusted and isolated computing environment in which a dataset to be processed by an algorithm is received in encrypted form from a dataset-providing computational domain of an entity that is authorized to provide the dataset, the dataset being encrypted by a first encryption key, the controlling trusted and isolated computing environment providing the dataset-providing computational domain with a second encryption key for encrypting the first encryption key; providing to the first trusted and isolated computing environment, from the controlling trusted and isolated computing environment, a first decryption key for decrypting the first encryption key such that the first trusted and isolated computing environment is able to decrypt the encrypted dataset without allowing any other computational domain to access the dataset in an unencrypted form except for the dataset-providing computational domain, wherein a trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate; wherein the first trusted and isolated computing environment obtains the algorithm that is to process the dataset by receiving the algorithm as an encrypted algorithm from an external storage system and decrypts the encrypted algorithm using a second decryption key obtained from the controlling trusted and isolated computing environment such that the first trusted and isolated computing environment is able to decrypt the encrypted algorithm without allowing any other computational domain to access the algorithm in an unencrypted form except for the computational domain of an entity that is authorized to provide the algorithm; and causing the algorithm to process the dataset in the first trusted and isolated computing environment to produce an output result.

In accordance with another aspect of the methods and systems described herein, the method further includes: providing from the controlling trusted and isolated computing environment to a designated recipient of the output result a second encryption key for encrypting a symmetric key provided to the designated recipient by the dataset-providing computational domain; receiving in the first trusted and isolated computing environment the encrypted symmetric key from the designated recipient; receiving a third decryption key in the first trusted and isolated computing environment from the controlling trusted and isolated computing environment for decrypting the encrypted symmetric key; decrypting the encrypted symmetric key in the first trusted and isolated computing environment using the third decryption key; and encrypting the output result in the first trusted and isolated computing environment using the symmetric key and storing the encrypted output result in a storage system external to the first trusted and isolated computing environment and the controlling trusted and isolated computing environment.

In accordance with another aspect of the methods and systems described herein, a method for securely receiving a dataset in a computing environment that is to process the dataset includes: receiving in a first trusted and isolated computing environment an encrypted dataset from a dataset-providing computational domain of an entity that is authorized to provide the dataset, wherein the encrypted dataset is only able to be decrypted in the first trusted and isolated computing environment using decryption keys available from the dataset-providing computational domain and a controlling trusted and isolated computing environment that generates the first trusted and isolated computing environment, wherein a trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate; and decrypting the encrypted dataset in the first trusted and isolated computing environment using the decryption keys such that the decrypted dataset cannot be accessed in an unencrypted form by any computational domain except for the computational domain of the entity that is authorized to provide the algorithm.

In accordance with another aspect of the methods and systems described herein, one of the decryption keys is a symmetric key received in the first trusted and isolated computing environment in an encrypted form and generated by the dataset-providing computational domain.

In accordance with another aspect of the methods and systems described herein, a second of the decryption keys is received in the first trusted and isolated computing environment from the controlling computational domain, wherein the second decryption key is configured to decrypt the symmetric key.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows one aspect of the systems and methods described herein in which datasets owned/provided by a data provider remain in the custody of the latter.

FIG. 2 shows one embodiment consistent with the arrangement shown in FIG. 1.

FIG. 3 shows an embodiment of the systems and methods described herein that is cognizant of the importance of constraints.

FIG. 4 shows an arrangement by which a computing environment created in computer can be trusted using the attestation module and supervisory programs.

FIG. 5 shows an example of a method for trusting secure computing environments.

FIG. 6A illustrates a first phase of a method by which secure computing environments may be used to effectuate remote executions of computer programs; FIG. 6B is a message flow diagram summarizing the method of phase 1 shown in FIG. 6A;

FIG. 6C illustrates a second phase of the method by which secure computing environments may be used to effectuate remote executions of computer programs in which the dataset provider prepares to provision its dataset using the controller which was created in phase 1; FIG. 6D is a message flow diagram summarizing the method of phase 2 shown in FIG. 6C; and FIG. 6E illustrates a third phase of the method by which secure computing environments may be used to effectuate remote executions of computer programs.

FIG. 7A shows the secure data pipeline for all three phases of the method illustrated in FIGS. 6A-6E; FIG. 7B is a message flow diagram summarizing the method illustrated in FIG. 7A; FIG. 7C shows the result of simplifying the pipeline in FIG. 7A by removing the computer cluster information and delineating the keys that are propagated from the controller to the various secure environments; FIG. 7D shows a further simplification of FIG. 7C in which the control plane has been removed; and FIG. 7E shows one particular embodiment of the more generalized case shown in FIG. 7C.

FIG. 8 shows an example of a secure data pipeline involving three parties.

FIG. 9 shows an example of a secure data pipeline involving a customized dataset.

FIGS. 10 and 11 show examples of a secure data pipeline involving a trained model.

### DETAILED DESCRIPTION

### Introduction

Modern business enterprises rely on data and programmatic assets in their business operations. For many enterprises, production of data and computer programs is the main business. Thus, it is commonplace to hear expressions such as “data is the new oil.” Many enterprises acquire and share data and computer programs. Thus, data and computer programs may rightfully be treated as assets.

It is well known that the technologies of machine learning, artificial intelligence, pharmaceutical drugs and medical/biological research and development require large datasets for training and development of high performing systems. Acquisition of such datasets is known to be a cumbersome but much needed activity.

When assets are shared, several questions arise pertaining to ownership, usage, intellectual property, rights adhering to the sharing, etc.

Sharing of assets may be further complicated if a shared asset contains private or sensitive data, e.g., a shared dataset may contain Patient Health Information (commonly abbreviated as PHI), or Patient Identity Information (PII).

Furthermore, acquisition of data creates additional risks and costs to the data acquiring enterprise. The acquired data must be transported from its storage area (typically a cloud system or a data lake, etc.) which is expensive. The communication links used for the transportation of data need to be made secure. The computing environment used for data processing needs to be secure against malicious attacks and intrusive computer programs. The processing of data and the ensuing output itself must preserve consumer data privacy according to regulations governing PII, such as GDPR (General Data Protection Regulations), HIPAA (Health Insurance Portability and Accountability Act), etc. The outputted data must be used or shared in a manner that preserves the regulations and privacy of consumer data. (For example, GDPR restricts the movement of certain kinds of datasets across jurisdictional boundaries; HIPAA imposes restrictions on the sharing of patient data, etc.)

Conventional approaches to the problems associated with data acquisition involve enacting legal contracts amongst the data providing and data processing entities. Many enterprises have instituted compliance departments to satisfy the legal contracts under which datasets are acquired.

In the discussions to follow, we use the terms data provider, (computer) program provider, and output receiver to denote entities that own or are otherwise legitimately authorized/entitled to provide datasets, own or are otherwise legitimately authorized/entitled to provide computer programs to process datasets, and entities that are legitimately authorized/entitled to receive the outputted results of the data processing activity, respectively. Often, data provider and program provider entities will be distinct. In some embodiments, the output receiver and the data provider or the program provider may be the same entity. In some embodiments, it will be convenient to describe an entity as playing a role, e.g., when describing an entity that is both a program provider and an output receiver. The term role thus refers to the actions or operational activities of entities. We sometimes use the term algorithm provider as a synonym for the term program provider. We also observe that we use the term “dataset” to denote various types of data irrespective of its storage method, e.g., we use the “data” to refer to structured data stored in database systems, unstructured data stored in file systems, cloud storage, digital images, electrocardiogram (ECG) data, real-time data being served through some networked system such as Kafka queues, etc.

We often use the terms program and algorithm interchangeably, but we note that as used herein the terms algorithm and program denote the availability of source code. Thus, for example, when we refer to “encrypting/decrypting a program/algorithm”, we shall be referring to encrypting the source code of the program/algorithm.

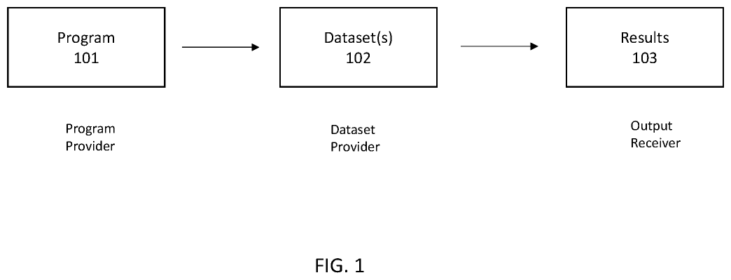

FIG. 1 shows one aspect of the present invention in which datasets owned/provided by a data provider remain in the custody of the latter. We give a computational meaning to the term custody in the sense that the dataset remains in the computational domain (e.g., a cloud domain or an Intranet or a private network) of the data provider. In this embodiment, computer programs (101) are made available to the data provider (102), i.e., the “program travels to the data,” or “compute (asset) is brought to the data.” Once the dataset has been processed, the output is then made available to the output receiver (103). (Entities 102 and 103 may be the same entity playing different roles.)

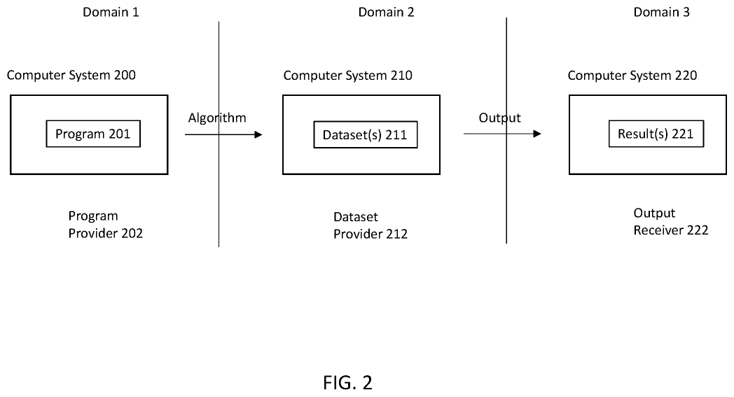

FIG. 2 shows one embodiment consistent with the arrangement shown in FIG. 1. The role of the program provider 202 is enabled by a computer system 200 programmed to provide a computer program 201. That is, computer system 200 (more precisely, the CPU of 200) treats computer program 201 as “data” by not interpreting the logic of program 201.

The role of the dataset provider 212 is enabled by a computer system 210 that contains datasets 211. The role of the output receiver 222 is enabled by computer system 220 that is programmed to receive results 221. Details of the programming of computer systems 200, 210 and 220 will be provided later, but a partial and simple operational explanation may be arrived at as follows.

Computer system 210 may receive program 201 and use it to process datasets 211. It may then transmit the results of the processing to computer system 220. Other operational methods (e.g., in one such method, the data may travel and be provided to the compute asset) can also be envisaged by those of ordinary skill in the art.

The above simple operational explanation does not address the crucial detail of constraints that may be imposed by the data provider, program provider and/or output receiver entities. Examples of such constraints are provided as follows.

A program provider entity may require that its intellectual property in the form of the computer program be protected. Thus, no entity should be able to view, edit, copy, or modify the computer program. Only a pre-determined and identified dataset may be provided to the computer program for processing. The processing itself may be subject to constraints, e.g., the computer program may process the dataset for a pre-determined period, or have access to selected updated versions of the dataset, etc.

A data provider entity may require that its dataset not be copied, duplicated, edited, modified, or transmitted outside its domain. It may require that only pre-determined and identified computer programs may process its dataset. (Some commercial enterprises refer to computer programs that have been pre-determined and identified as “curated.”) It may further require that the outputted results may be provided only to designated entities.

The output receiver entity may require that the results it receives may not contain any personal or protected health information of consumers, etc. The data provider and program provider may both require that the output receiver may not share the provided results with any other entity.

Thus, the simple, operational method described above with reference to FIG. 2 breaks down when we consider constraints that appear to be quite common in the commercial world.

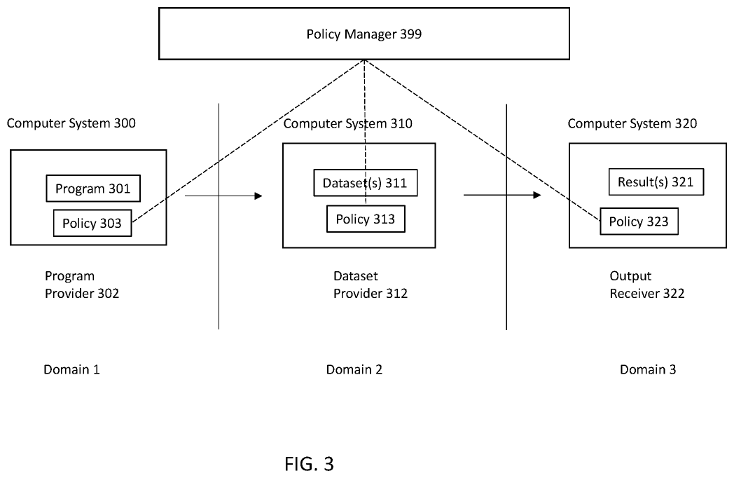

FIG. 3 shows an embodiment of the present invention that is cognizant of the importance of constraints. The constraints of each entity are captured as a data structure referred to as apolicy. Thus, policy elements 303, 313 and 323 represent the computational form of the constraints of the program provider 302, data provider 312 and output receiver 322, respectively. A computational entity, policy manager 399, then represents a programmatic entity that enforces the policies 303, 313 and 323 in domains 1, 2 and 3, respectively.

The descriptions that follow are meant to provide illustrative embodiments that are able to implement the architecture shown in FIG. 3. We shall also provide illustrative examples to further elucidate and explain those embodiments, which are presented by way of illustration only and not as a limitation on the systems, architectures and methods described herein.

We take the opportunity to express some general comments about the invention with respect to FIG. 3 that are noteworthy.

If the output receiver entity is distinct from the data provider and/or the program provider, and since it never comes into possession of the dataset or the program upon which the results are based, can it trust the results 321?

Trusting the (results of) the execution of computer programs in remote—in the sense of being inaccessible—computing environments has important commercial consequences some of which we highlight later by providing illustrative embodiments.

User/Endpoint Devices

The term user, client, edge or endpoint device as used herein refers to a broad and general class of computers used by consumers including but not limited to smart phones, personal digital assistants, laptops, desktops, tablet computers, IoT (Internet of Things) devices such as smart thermostats and doorbells, digital (surveillance) cameras, etc. The list includes one or more devices associated with (using wireless or wired connections) user/endpoint devices, e.g., smart watches, fitness bracelets, consumer health monitoring devices, environment monitoring devices, home monitoring devices such as smart thermostats, smart light bulbs, smart locks, smart home appliances, etc.

Trusted and Isolated Computing Environments

Given the prevalent situation of frequent malicious attacks on computing machinery, there is concern that a computer program may be hijacked by malicious entities. Can a program's code be secured against attacks by unauthorized and malicious entities and hence be trusted?

One possibility is for an enterprise to develop a potential algorithm and put it up in a publicly accessible place where it may be analyzed, updated, edited and improved by the developer community. After some time during which this process has been used, the algorithm can be “expected” to be reasonably safe against intrusive attacks, i.e., it garners some trust from the user community. As one learns more from the experiences of the developers, one can continue to increase one's trust in the algorithm. However, complete trust in such an algorithm can never be reached for any number of reasons, e.g., bad guys may simply be waiting for a more opportune time to strike.

It should be noted that Bitcoin, Ethereum and certain other cryptocurrencies, and some open-source enterprises use certain methods of gaining the community's trust by making their source code available on public sites. Any person may then download the software so displayed and, e.g., become a “miner,” i.e., a member of a group that makes processing decisions based on the consensus of a majority of the group.

U.S. patent application Ser. No. 17/094,118, which is incorporated by reference herein in its entirety, proposes a different method of gaining trust. As discussed therein, a computation is a term describing the execution of a computer program or algorithm on one or more datasets. (In contrast, an algorithm or dataset that is stored, e.g., on a storage medium such as a disk, does not constitute a computation.) The term process is used in the literature on operating systems to denote the state of a computation and we use the term—process—to mean the same herein. A computing environment is a term for a process created by software contained within the supervisory programs, e.g., the operating system of the computer (or cluster of computers), that is configured to represent and capture the state of computations, i.e., the execution of algorithms on data, and provide the resulting outputs to recipients as per its configured logic. The software logic that creates computing environments (a type of process) may utilize the services provided by certain hardware elements of the underlying computer (or cluster of computers).

As used herein, a computing cluster may refer to a single computer, a group of networked computers or computers that otherwise communicate and interact with one another, and/or a group of virtual machines. That is, a computing cluster refers to any combination and arrangement of computing entities.

U.S. patent application Ser. No. 17/094,118 creates computing environments which are guaranteed to be isolated and trusted. As explained below, an isolated computing environment is an environment that supports a fixed or maximum number of application processes and specified system processes. A trusted computing environment is an environment in which the digest (described below) of the code running in the environment has been verified against a baseline digest. (Such verifications based on matching digests, etc., may be operationalized using Certificate Authority (CA).

We may use (cryptographic) hash functions to create technology that can be used to create computing environments that can be trusted. One way to achieve trust in a computing environment is by allowing the code running in an environment to be verified by using cryptographic hash functions/digests.

That is, a computing environment is created by the supervisory programs which are invoked by commands in the boot logic of a computer at boot time which then use hash functions, e.g., SHA-256 (available from the U.S. National Institute of Standards and Technology), to take a digest of the created computing environment. This digest may then be provided to an escrow service to be used as a baseline for future comparisons.

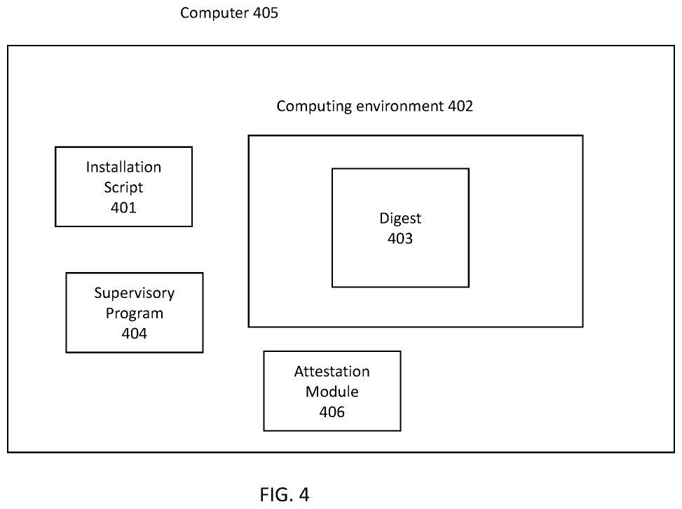

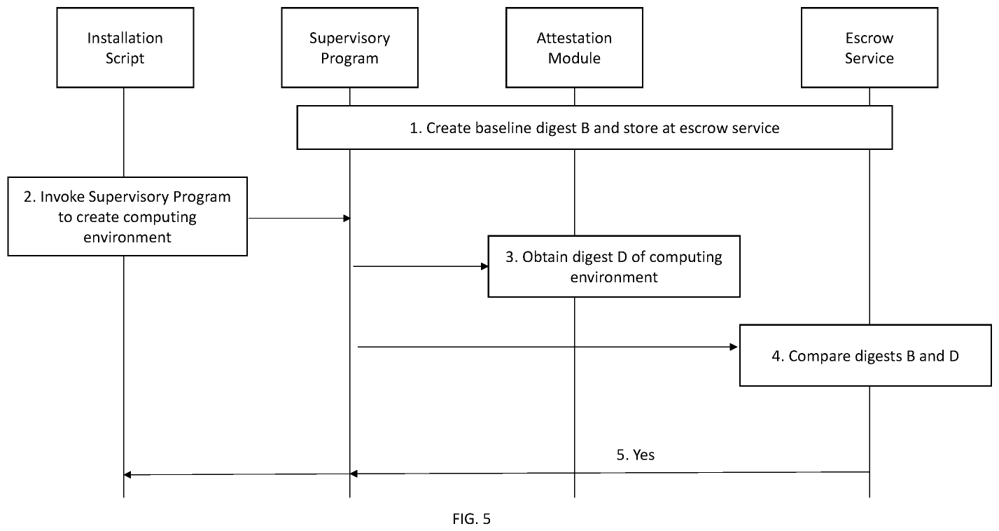

FIG. 4 shows an arrangement by which a computing environment 402 created in computer 405 can be trusted using the attestation module 406 and supervisory programs 404.

FIG. 5 shows the method for trusting the computing environment 402.

Method: Attest a computing environment
Input: Supervisory program 404 of a computer 405 provisioned with attestation module 406, installation script 401.
   Output: “Yes” if computing environment 402 can be trusted, otherwise “No.”
1. Provisioning step: Boot the computer. Boot logic is configured to invoke attestation method. Digest is obtained and stored at escrow service as “baseline digest, B.”
2. Initiate installation script which requests supervisory programs to create computing environment.
3. Logic of computing environment requests Attestation Module to obtain a digest D of the created computing environment.
4. Logic of computing environment requests escrow service to match the digest D against the baseline digest, B.
5. Escrow service reports “Yes” or “No” accordingly to the logic of the computing environment which, in turn, informs the installation script.

Note that the installation script is an application-level computer program. Any application program may request the supervisory programs to create a computing environment which then use the above method to verify if the created environment can be trusted. Boot logic of the computer may also be configured, as described above, to request the supervisory programs to create a computing environment.

Whereas the above process can be used to trust a computing environment created on a computer, we may in certain cases require that the underlying computer must be trusted as well. That is, can we trust that the computer was booted securely and that its state at any given time as presented by the contents of its internal memory registers can be trusted.

The attestation method may be further enhanced to read the various PCRs (Platform Configuration Registers), e.g., taken from a Trusted Platform Module (TPM) and take a digest of their contents. In practice, we may concatenate the digest obtained from the PCRs with that obtained from a computing environment (e.g., such as a Virtual Machine, VM) and use that as a baseline for ensuring trust in the boot software and the software running in the computing environment. In such cases, the attestation process which has been upgraded to include PCR attestation may be referred to as a measurement. Accordingly, in the examples presented below, all references to obtaining a digest of a computing environment are intended to refer to obtaining a measurement of the computing environment in alternative embodiments.

The enhanced attestation method described above may be used in computer systems that are not provided or provisioned with a secure boot process or those that do not provide process level support for isolation.

Note that a successful measurement of a computer implies that the underlying supervisory program has been securely booted and its state and that of the computer as represented by data in the various PCR registers is the same as the original state, which is assumed to be valid since we may assume that the underlying computer(s) are free of intrusion at time of manufacturing. Different manufacturers provide facilities that can be utilized by the Attestation Module to access the PCR registers. For example, some manufactures provide a hardware module called TPM (Trusted Platform Module) that can be queried to obtain data from PCR registers.

As mentioned above, U.S. patent application Ser. No. 17/094,118 also creates computing environments which are guaranteed to be isolated in addition to being trusted. The notion of isolation is useful to eliminate the possibility that an unknown and/or unauthorized process may be “snooping” while an algorithm is running in memory. That is, a concurrently running process may be “stealing” data or effecting the logic of the program running inside the computing environment. An isolated computing environment can prevent this situation from occurring by using memory elements in which only one or more authorized (system and application) processes may be concurrently executed.

The manner in which isolation is accomplished depends on the type of process that is involved. As a general matter there are two types of processes that may be considered: system and application processes. An isolated computing environment may thus be defined as any computing environment in which a specified maximum number of application processes and specified system processes implementing the computing environment are able to operate. System processes are allowed access to an isolated memory segment if they provide the necessary keys. For example, Intel Software Guard Extension (SGX) technology uses hardware/firmware assistance to provide the necessary keys. Application processes are also allowed entry to an isolated memory segment based on keys controlled by hardware/firmware/software element called the Access Control Module, ACM (described later).

Typically, system processes needed to create a computing environment are known a priori to the supervisory program and can be configured to ask and be permitted to access isolated memory segments. Only these specific system processes can then be allowed to run in an isolated memory segment. In the case of application processes such knowledge may not be known a priori. In this case, developers may be allowed to specify the keys that an application process needs to gain entry to a memory segment. Additionally, a maximum number of application processes may be specified that can be allowed concurrent access to an isolated memory segment.

Computing environments are created by code/logic available to supervisory programs of a computer (or cluster of computers). This code may control which specific system processes are allowed to run in an isolated memory segment. On the other hand, as previously mentioned, access control of application processes is maintained by Access Control Modules.

It is important to highlight the difference between trusted and isolated computing environments. An isolated computing environment is an environment that supports a fixed or maximum number of application processes and specified system processes. A trusted computing environment is an environment in which the digest of the code running in the environment has been verified against a baseline digest.

As an example of the use of isolated memory as an enabling technology, consider the creation of a computing environment as discussed above. The computing environment needs to be configured to permit a maximum number of (application) processes for concurrent execution. To satisfy this requirement, SGX or SEV technologies can be used to enforce isolation. For example, in the Intel SGX technology, a hardware module holds cryptographic keys that are used to control access by system processes to the isolated memory. Any application process requesting access to the isolated memory is required to present the keys needed by the Access Control Module. In SEV and other such environments, the supervisory program locks down the isolated memory and allows only a fixed or maximum number of application processes to execute concurrently.

Consider a computer with an operating system that can support multiple virtual machines (VMs). (An example of such an operating system is known as the Hypervisor or Virtual Machine Monitor, VMM.) The hypervisor allows one VM at a given instant to be resident in memory and have access to the processor(s) of the computer. Working as in conventional time sharing, VMs may be swapped in and out, thus achieving temporal isolation.

Therefore, to achieve an isolated environment, a hypervisor like operating system may be used to temporally isolate the VMs and, further, allow only specific system and a known (or maximum) number of application processes to run in a given VM.

As previously mentioned, U.S. patent application Ser. No. 17/094,118 introduced the concept of Access Control Modules (ACM), which allow application processes entry to an isolated memory segment based on keys controlled by hardware/firmware/software element called the Access Control Module (ACM). ACMs are hardware/firmware/software components that use public/private cryptographic key technology to control access. An entity wishing to gain access to a computing environment must provide the needed keys. If it does not possess the keys, it will need to generate the keys to gain access which will require it to solve the intractable problem corresponding to the encryption technology deployed by the ACM, i.e., assumed to be a practical impossibility.

Access to certain regions of memory can also be controlled by software that encrypts the contents of memory that a CPU (Central Processing Unit) needs to load into its registers to execute, i.e., the so-called fetch-execute cycle. The CPU then needs to be provided the corresponding decryption key before it can execute the data/instructions it had fetched from memory. Such keys may then be stored in auxiliary hardware/firmware modules, e.g., Hardware Security Module (HSM). An HSM may then only allow authorized and authenticated entities to access the stored keys.

It is important to note that though a computing environment may be created by supervisory programs, e.g., operating system software, the latter may not have access to the computing environment. That is, mechanisms controlling access to a computing environment are independent of mechanisms that create said environments.

Thus, the contents of a computing environment may not be available to the supervisory or any other programs in the computing platform. An item may only be known to an entity that deposits it in the computing environment. A digest of an item may be made available outside the computing environment and it is known that digests are computationally irreversible.

Computing environments that have been prepared/created in the above manner can thus be trusted since they can be programmed to not reveal their contents to any party. Data and algorithms resident in such computing environments do not leak. In subsequent discussions, computing environments with this property are referred to as secure (computing) environments.

Policy Controlled Remote Executions of Computer Programs

We now demonstrate methods by which secure computing environments may be used to effectuate remote executions of computer programs. We present the description in three phases. The three phases may collectively constitute a data pipeline, and in particular a secure data pipeline of the type shown in PCT/US22/23671 [Docket No. 12701/10], which is incorporated by reference herein in its entirety.

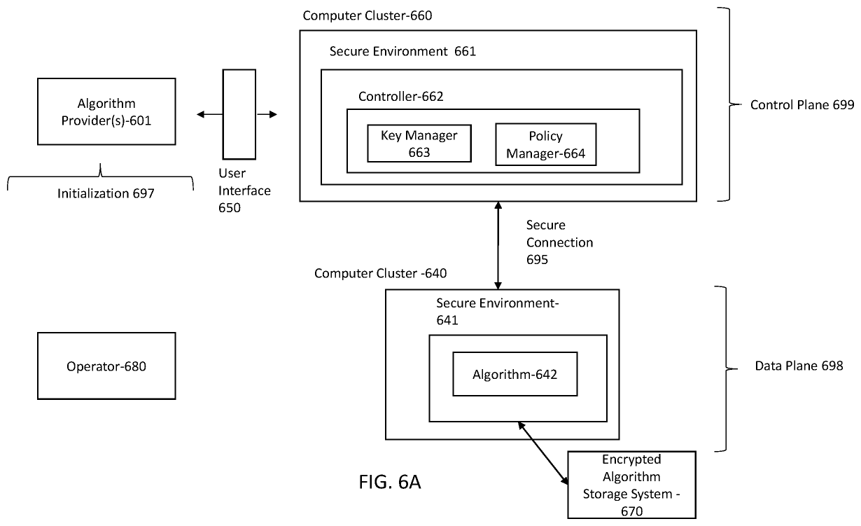

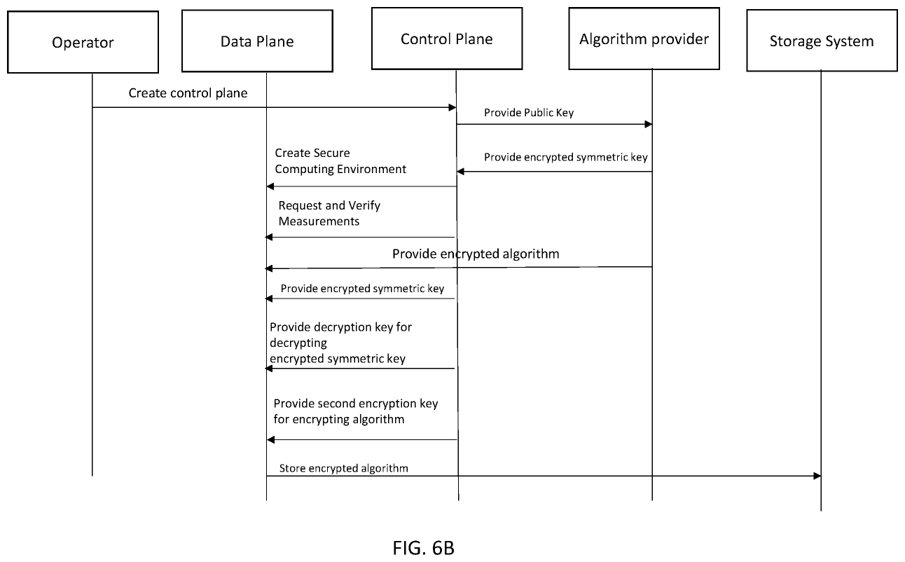

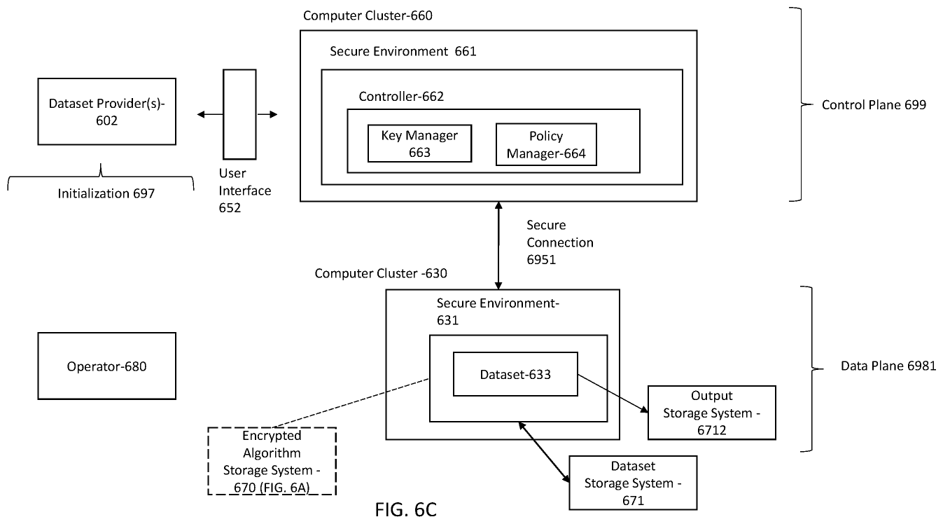

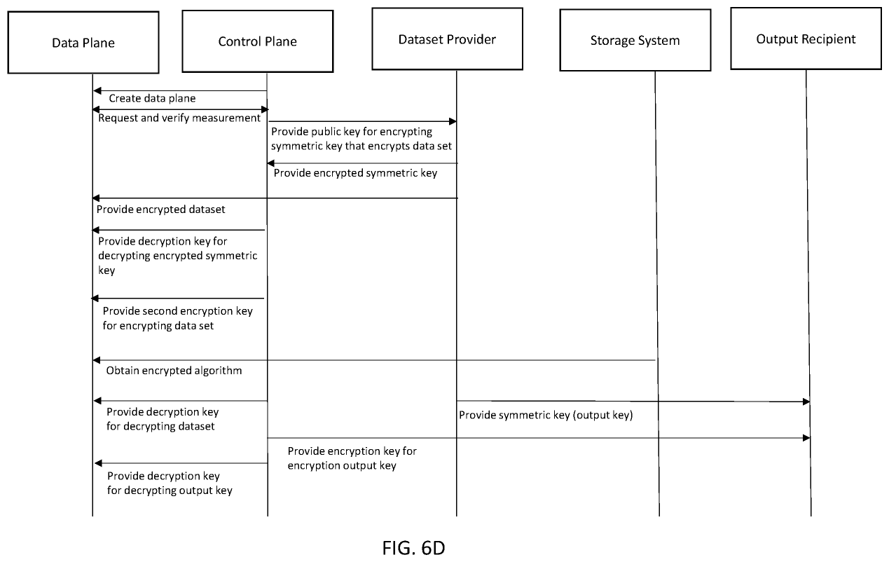

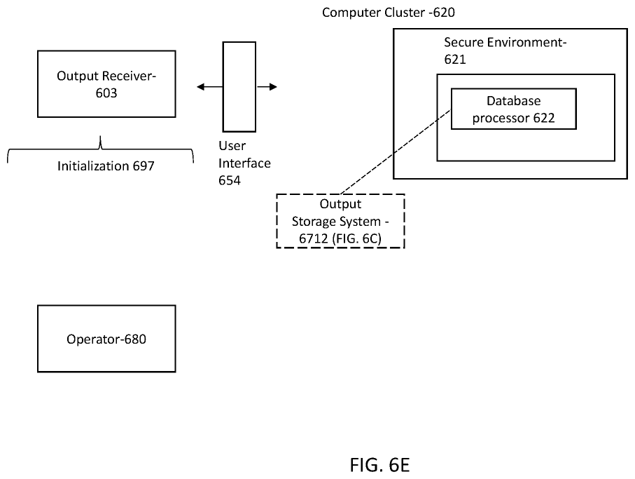

In phase 1, as shown in FIG. 6A, algorithm provider 601 is prepared to provide its program/algorithm 642 (An arrangement such as this may be achieved by an out of band agreement between the data and program/algorithm providers.)

We begin by creating a secure computing environment 661 on computing cluster 660 using the method of FIG. 5. (This step may be performed by any entity, but preferentially by the operator or the sharing service provider.) Secure computing environment 661 contains computer program 662 called Controller. In turn, Controller 662 contains two sub programs, Key Manager 663, and Policy Manager 664. (Programs 663 and 664 may be thought of as subroutines or more aptly as entry points available to the Controller program.) It will be convenient to refer to the entire arrangement implemented on the cluster 660 as the control plane 699.

Controller 662 is responsive to a user interface 650 associated with the algorithm provider that may be utilized by external programs to interact with it. That is, the user interface 650 is located in the algorithm provider's domain and not the controller's domain. Rather than detail the various commands available in user interface 650, we will describe the commands as they are used in the descriptions below.

Algorithm provider 601 indicates (using commands of user interface 650) to Controller 662 that it wishes to deposit algorithm 642. The user interface 650 employs a program to generate a symmetric key and provides the symmetric key to the algorithm provider who uses it to encrypt the algorithm 642. The Controller 662 requests Key Manager 663 to generate a first secret/public key pair (also known as decryption/encryption keys, respectively). The Key Manager 663 requisitions the underlying hardware to generate a private-public key pair. The public key component is provided to the algorithm provider 601 who uses it to encrypt the symmetric key used to encrypt the algorithm 642, and provides the encrypted symmetric key to the Controller 662. Controller 662, upon receipt, deposits the received information in Policy Manager 664.

Additionally, the algorithm provider 601 may use interface 650 to provide Controller 662 various policy statements that govern/control access to the algorithm 642. Various such policies are described in U.S. patent application Ser. No. 17/094,118. In the descriptions herein, we assume a policy that specifies that the operator 680 is not allowed access to the algorithm 642 or (as detailed below) the dataset, etc. Policy Manager 664 manages the policies provided to it by various entities.

Controller 662 may now invoke supervisory programs to create secure computing environment 641 (using method shown in FIG. 5) on computer cluster 640. Note that whereas the present embodiment being discussed herein requires that cluster 640 and 660 be distinct (since we are considering remote execution of computer programs), in other embodiments the two computing environments 661 and 641 may be created on a single cluster. Controller 662 and computing environment 641 communicate via connection 695 using secure communication protocols and technologies such as (Mutual) Transport Layer Security (TLS) or IPS (Inter-Process Communication), etc.

Controller 662 may now request and receive an attestation/measurement from secure environment 641 to verify that 641 is secure using the method of FIG. 5. This attestation/measurement, if successful, establishes that environment 641 is secure since its code base is the same as the baseline code (in escrow).

Once verified, the secure computing environment may then request and receive the encrypted algorithm 642 from the algorithm provider 601. Controller 662 may provide secure computing environment 641 the encrypted symmetric key that was used to encrypt the algorithm 642. To use the symmetric key, secure computing environment 641 needs to first decrypt it. Secure computing environment 641 requests and receives from controller 662/Key Manager 663 the corresponding decryption/secret key. (This decryption key corresponds to the encryption key provided to the algorithm provider above.) Once decrypted the symmetric key can be used to decrypt the algorithm 642 in the secure environment 641. The algorithm 642 is then be encrypted again by asking the controller 662 to generate a second decryption/encryption key pair and using a new (i.e., a second) encryption key to encrypt the algorithm 642. Controller 662 retains control of the corresponding second secret key. This second pair of keys is referred to as the ALG-key pair. (The encrypted algorithm will be used in phase 2; hence, the secret key will be needed in phase 2.) Secure computing environment 641 may then deposit the encrypted algorithm in storage 670.

It will be convenient to refer the arrangement created on computer cluster 640 as data plane 698.

We summarize the above steps as follows (cf. FIGS. 6B and 6A).
Operator creates control plane 699 (containing Controller 662).
Algorithm provider 601 obtains symmetric key using the user interface 650 and encrypts the algorithm 642.
The control plane 699 provides the public key of the public/private key pair to the algorithm provider 601.
Control plane 699 requests and receives from the algorithm provider 601 the encrypted symmetric key that encrypted the algorithm 642. Control Plane 699 creates secure computing environment 641 (data plane 698).
Control plane requests and receives measurements so it may trust data plane 698.
Data plane 698 requests and receives the encrypted algorithm 642 from the algorithm provider 601.
Data plane 698 requests and receives from the controller 662 the encrypted symmetric key used to encrypt the algorithm 642.
Data plane 698 requests and receives from the controller 662 the corresponding decryption key for decrypting the encrypted symmetric key.
The secure computing environment 641 decrypts the symmetric key, which is then used to decrypt the algorithm 642.
Data plane 698 requests and receives from the controller 662 a second encryption key of a second encryption/decryption key pair (the ALG-key pair) for encrypting the algorithm.
The secure computing environment encrypts the algorithm 642 using the second encryption key in the second encryption/decryption key pair (the ALG-key).
The encrypted algorithm 642 is stored in storage system 670.
Data plane 698 informs control plane that it is ready for further instructions.

As a parenthetical note, we use the term storage system in a generic sense. In practice, a file system, a data bucket, a database system, a data warehouse, a data lake, live data streams or data queues, etc., may be used to effectuate input and output of data.

We note that in the entire process outlined and detailed above, the operator never comes into possession of the secret keys generated and stored within Controller 662. The secret keys remain inside the secure environments 661 and 641. Thus, the operator 680 is unable to access algorithm 642.

The above concludes phase 1. Note that at the conclusion of phase 1, the encrypted algorithm 642 is stored in storage system 670 (FIG. 6A) and the controller has the corresponding (second) secret/decryption key, which is referred to as the ALG decryption key of the ALG-key pair.

In phase 2, as shown in FIG. 6C, the dataset provider 602 prepares to provision its dataset 633 using controller 662 which was created in phase 1 above.

Dataset provider 602 indicates, using commands of a user interface 652 associated with the dataset provider 602, to Controller 662 that it wishes to provide dataset 633. It also encrypts the dataset 633 using a symmetric key that is generated using a program associated with the user interface 652. Controller 662 requests Key Manager 663 to generate a secret/public key pair which uses the underlying hardware to obtain the requested public-private key pair. It provides the public key component to dataset provider 602. The dataset provider encrypts its dataset using the symmetric key and encrypts the symmetric key using the provided public key and provides the encrypted symmetric key to the Controller 662. Controller 662 upon receipt deposits the received information in Policy Manager 664.

Additionally, the dataset provider 602 may use interface 652 to provide Controller 662 various policy statements that govern/control access to the dataset. Various such policies are described in U.S. patent application Ser. No. 17/094,118. In the descriptions herein, we assume a policy that specifies that the operator 680 is not allowed access to the algorithm (or as detailed below) the dataset, etc. Policy Manager 664 manages the policies provided to it by various entities.

Controller 662 may now invoke supervisory programs to create secure environment 631 (using method shown in FIG. 5) on computer cluster 630. Controller 662 and environment 631 communicate via connection 6951 using secure communication protocols and technologies such as (Mutual) Transport Layer Security (TLS) or IPS (Inter-Process Communication), etc.

Controller 662 may now request and receive an attestation/measurement from secure environment 631 to verify that 631 is secure using the method of FIG. 5. This attestation/measurement, if successful, establishes that environment 631 is secure since its code base is the same as the baseline code (in escrow).

Once verified, the secure computing environment may request and receive the encrypted dataset 633 from the dataset provider 602. Controller 662 may provide secure computing environment 631 the encrypted symmetric key used to encrypted the dataset 633. To use the symmetric key, secure environment 631 needs to first decrypt it. Secure computing environment 631 requests Controller 662 to provide the decryption key to decrypt the symmetric key, which the secure environment 631 uses to decrypt the dataset 633. The dataset 633 may then be encrypted again by asking controller 662 to generate a second decryption/encryption key pair. The second encryption key is provided to the secure environment 631, which uses the second encryption key to encrypt the dataset 633.

We will refer to the second public-private key pair as DATA-Keys.

Furthermore, secure computing environment 631 accesses the code of algorithm 642 (cf. FIG. 6A) from storage system 670 (cf. FIG. 6A). Secure computing environment 631 decrypts the code of algorithm 642 for which it first obtains from the controller 662 the decryption/secret key that was used to encrypt it, which is the decryption key in the previously defined ALG-Key pair. (In FIG. 6C, encrypted algorithm in storage system 670 is shown using dashed lines.) Environment 631 also needs to decrypt dataset 633 using the decryption key in the DATA-key pair, which it also may obtain from the Controller 662.

Once the dataset and the algorithm have been decrypted, algorithm 642 processes dataset 633 to produce an output result(s).

Optionally, dataset provider 602 may require the output result(s) to be encrypted using a symmetric key (which is generated using its associated user interface) that will be provided to the output receiver that is to receive the output result(s). This symmetric key is referred to as the OUTPUT key. In such a case, controller 662 provides a public key to the output receiver to encrypt the OUTPUT key and provides the encrypted OUTPUT key to the secure computing environment 631. Controller 662 provides the corresponding private key to secure computing environment 631, which uses it to decrypt the OUTPUT key. In turn, the secure computing environment 631 uses the decrypted OUTPUT key to encrypt the output result(s), which are then stored in output storage system 6712.

It will be convenient to refer to the arrangement created on computer cluster 630 as data plane 6981.

We summarize the above steps of phase 2 as follows (cf. FIG. 6D).
Operator has previously created control plane 699 (containing Controller 662) in phase 1.
Control Plane 699 creates data plane 6981.
Control plane 699 requests and receives measurements so it may trust data plane 6981.
Dataset provider 602 obtains symmetric key using the user interface 652 and encrypts the dataset 633.
The control plane 699 provides the public key of the public/private key pair to the dataset provider 602 for encrypting the symmetric key.
Control plane 699 requests and receives from the database provider 602 the encrypted symmetric key used to encrypt the dataset 633.
Data plane 6981 requests and receives the encrypted dataset 633 from the dataset provider 602.
Data plane 6981 requests and receives from the controller 662 the encrypted symmetric key used to encrypt the dataset 633.
Data plane 6981 requests and receives from the controller 662 the corresponding decryption key for decrypting the encrypted symmetric key.
Data plane 6981 requests and receives from the controller 662 a second encryption key of a second encryption/decryption key pair (the DATA-key pair) for encrypting the dataset.
Data plane 6981 accesses the encrypted algorithm 642 from storage system 670.
Data plane 6981 requests and receives from the controller 662 the decryption key that was used to encrypt the algorithm (the decryption key of the ALG-key pair).
Data plane 6981 requests and receives from the controller 662 the decryption key for decrypting the dataset 633 (the decryption key of the DATA-key pair).
Secure computing environment 631 processes decrypted dataset 633 using the decrypted algorithm 642 to generate output result(s).
Data set provider 602 generates a symmetric key (the OUTPUT key) and provides it to the output recipient.
Controller 662 provides output recipient with a new public key and output recipient encrypts the OUTPUT key and provides it to the secure computing environment 631.
Controller 662 provides decryption key to secure computing environment 631 for decrypting the encrypted OUTPUT key.
Secure computing environment 632 uses the decrypted OUTPUT key to encrypt the output result(s) and store them in the output storage system 6712.
Data plane 6981 informs control plane that it is ready for further instructions.

We note that, as in phase 1, the operator never comes into possession of the secret keys generated and stored within Controller 662. Furthermore, the program provider (601, cf. FIG. 6A) never comes into possession of the decryption keys of the dataset 633.

The above concludes phase 2.

In phase 3, as shown in FIG. 6E, the output receiver 603 prepares to receive the output result(s) stemming from the execution of program 642 (cf. FIG. 6A) on dataset 633 (cf. FIG. 6C). Further note that controller 662 on cluster 660 was created in phase 1 above.

Recall that the output receiver 603 possesses the symmetric key (OUTPUT-Key). It may use it to access the Output Storage System 6712 and decrypt the outputted result(s).

In the above discussion we have assumed that the dataset 633 can be loaded into secure environment 631 (FIG. 6C). In many practical situations, the dataset 633 may be too large to be fully loaded into a secure environment. In such cases, the dataset is stored in an external storage system (e.g., a data lake) and credentials are needed to access the data. Typically, a computer program called database processor is used to manage and provide such access credentials.

To accommodate and enable large datasets, FIG. 6E shows the outputted results (from Phase 2 above) stored in an external storage system 6712 which is being accessed by a database processor 622.

Note that database processor 622 is shown in FIG. 6E as running in a secure environment 621. But this arrangement is optional. Program 622 may run in a non-secure environment as well.

The advantage of running program 622 in a secure environment is that the symmetric key used to access and decrypt the outputted results is provided to the Controller 662 by the output receiver in encrypted form (and is thus secure) and, furthermore, the symmetric key remains secure inside Controller 662 and is provided only to programs, e.g., 622, running in secure environments, e.g., 621. Additionally, the transport between secure environments is secure.

In a preferred embodiment, the database processor 622 runs in secure environments.

The above concludes phase 3.

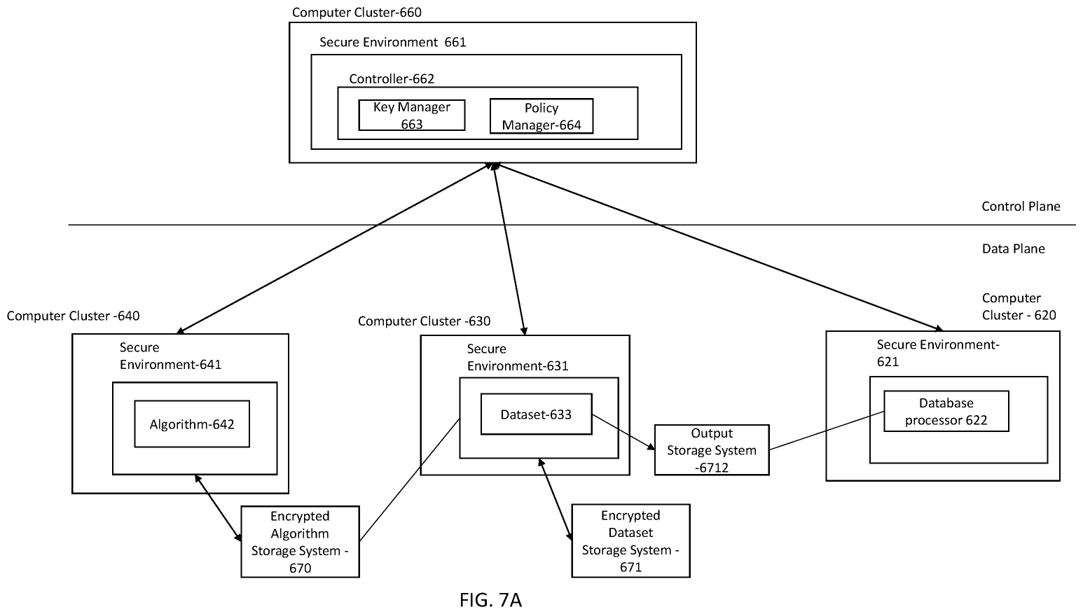

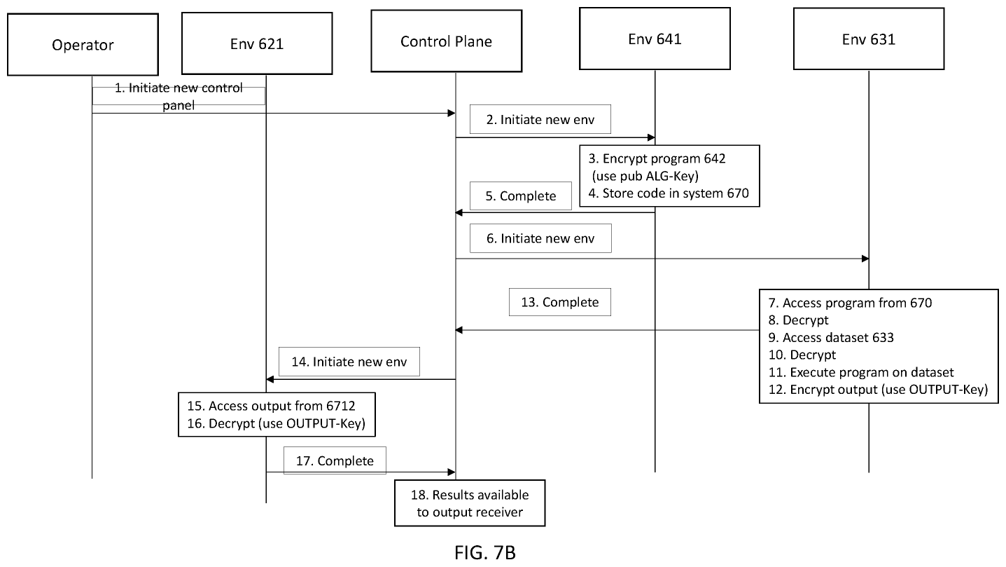

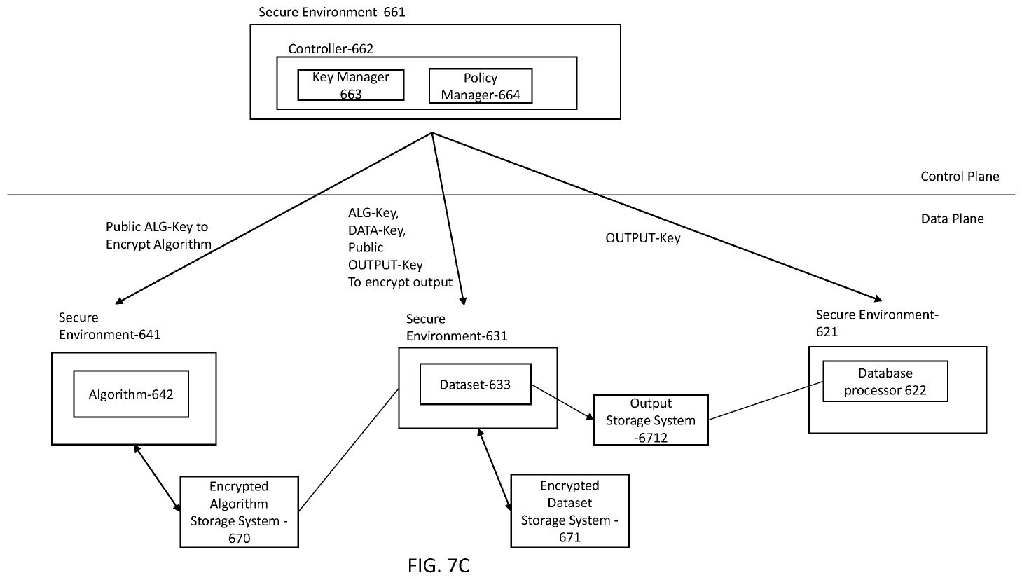

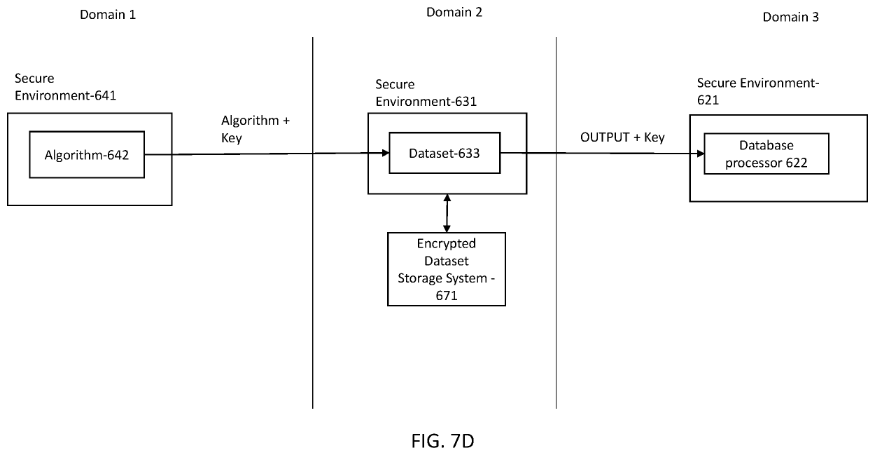

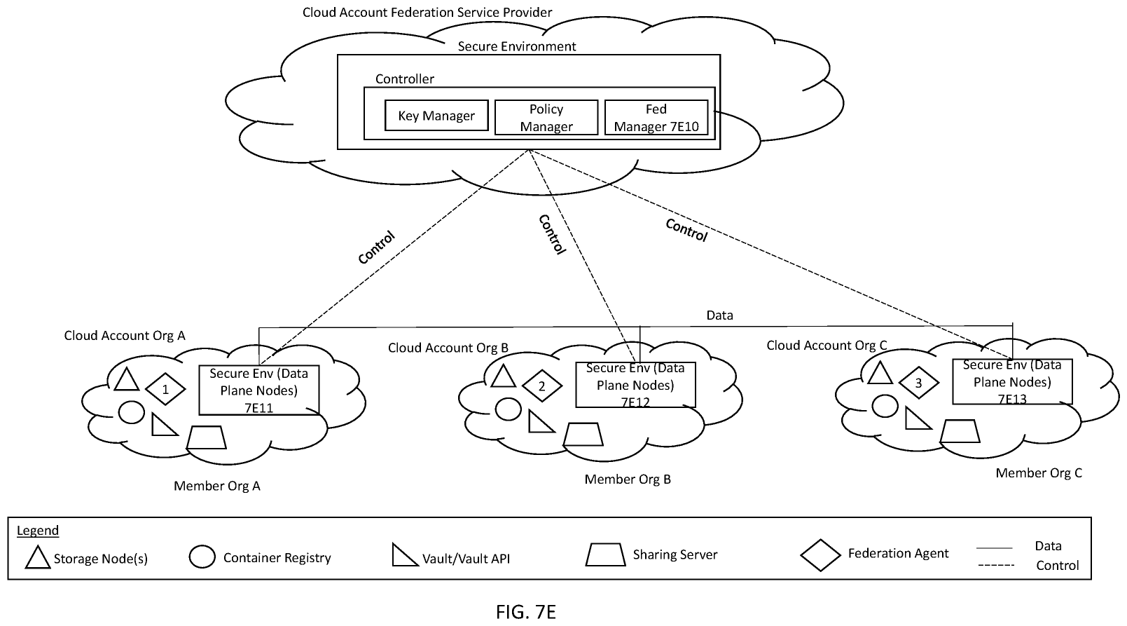

FIG. 7A shows the result of combining FIGS. 6A, 6C and 6E. We now need to describe the computation of results from start to finish.

The method proceeds as follows.
I. Operator initiates the computation by triggering the controller 662.
II. Controller 662 triggers secure computing environment 641 which, in turn, initiates the encryption of program 642 (using a symmetric key and the latter being encrypted using a public ALG-Key) and its subsequent storage in storage system 670. Environment 641 informs controller 662 at the completion of its step.
III. Controller 662 triggers secure computing environment 631 which causes secure computing environment 631 to access the encrypted algorithm from storage system 670, decrypt its symmetric key using the (private) ALG-Key and decrypt the algorithm. Next, using the private DATA-Key obtained from Controller 662, 631 accesses and loads the dataset 633 and executes algorithm 670 on dataset 633. The output is encrypted using the OUTPUT-Key and stored in system 6712. The controller 662 is informed of the completion of this step.
IV. Controller 662 triggers secure computing environment 621 which, in turn, causes program 622 to access the stored output 6712, and decrypt the retrieved data using the OUTPUT-key.
V. The results of the computation are now available to the output-receiver.

FIG. 7B delineates the above method.

FIG. 7C shows the result of simplifying FIG. 7A by removing the computer cluster information and delineating the keys that are propagated from the controller to the various secure environments.

FIG. 7D is a further simplification of FIG. 7C in which the control plane has been removed. It may be instructive for reasons of clarity to compare FIGS. 2 and 7D. Note that FIG. 2 proposed that the algorithm be made available to the dataset provider, and the corresponding output to the output receiver. Importantly, the dataset is to remain in the domain of the dataset provider.

The technology of secure environments allows an encrypted algorithm to be provided to the dataset provider whose corresponding decryption key is only available within a secure environment operating in the domain of the dataset provider.

Additionally, the output of the ensuing computation by the algorithm on the dataset provided by the dataset provider is provided in encrypted form to the output receiver, and the corresponding decryption key is only available inside a secure environment operating in the output receiver's domain.

Audit Log and Verification of Executions

We have remarked earlier that the executions of computer programs in secure environments can be trusted since they can be verified. We now discuss the verification of program executions.

In some embodiments, every action carried out by a computing entity in the system described herein (FIGS. 6B, 6D, 6F and culminating in FIG. 7B) creates (“logs”) a record of those actions. Below we list the various actions shown in FIG. 6B.
1. Create control plane
2. Request & receive links to algorithm
3. Create data plane
4. Request & verify measurement
5. Request & receive keys
6. Inform control plane

Each action listed above is a description of the actual commands/data used to implement the action. The corresponding log record will contain the detailed commands/data of the action. For example, action 1 above (“Create control plane”) will have the log data that shows the command/data generated by the operator, received by the control plane, commands used to create a new pipeline, etc.

Similarly, action 4 listed above (“Request and verify measurement”) will have a log record that shows the request to the environment for a measurement, receive the requested measurement, match the received measurement with the baseline measurement (cf. FIG. 4), and receive an affirmative response to the matching operation. The log will contain the public keys of all requests made all actors so that all accesses may be authenticated.

We can use the log record corresponding to action 4 to verify that the environment can be trusted as follows. The log record contains the digest received from the environment and the baseline digest. If we are provisioned with a suitable computer program, we may use the same to match the baseline digest with the digest provided by the environment. A successful match will indicate that the environment can be trusted.

As another example of verification, consider the log record corresponding to action 5 (“Request and receive keys”). The corresponding log data will contain the request for a public key component from the controller and the receipt of the requested key.

We can use a suitably provisioned computer program operating on the log record corresponding to action 5 to verify the policy controls as follows. Receipt of a public/encryption key indicates that the receiving entity can encrypt a program/data object. Receipt of a secret/decryption key indicates that the receiving entity can decrypt (and, thus, have access to) a program/data object.

We have thus shown that log records of FIGS. 6B, 6D, 6F, 7B taken together constitute a data record that can be analyzed by suitably provisioned computer programs to verify the integrity of the controller and the environments it engenders, and policy control mechanisms related to the pipelines under the aegis of the controller.

The various embodiments presented above illustrate various use cases, but the systems and techniques described herein are not limited to those use cases. As will be evident from the discussion below, the various embodiments also may be combined to produce several new service offerings or transform existing service offerings.

Types and Implementation of Policies

In the descriptions above we have considered policies that relate to the ownership of assets. We now describe several other types of policies.

One type of policies relates to enabling time-based access to an asset. For example, access to a dataset may be allowed for 1 week. Access may be allowed if a certain event occurs, e.g., second Wednesday of the month. Another type of policies relates to the number of accesses, e.g., access to a programmatic asset may be allowed for a certain number of uses or executions of the asset. Policies also may be specified that deny or allow access to assets based on the identity credentials of an account, an organization (e.g., all accounts belonging to an organization), etc. Policies also may relate to charges for use of assets and discounts thereof. For example, a policy may dictate that an asset may be used for a given time period for a certain charge.

Policies also may be specified that bind one or more assets to a given secure environment or a cluster of computers upon which one or more secure environments have been defined. (Computers in a cluster may be identified by keys generated by internal hardware elements of the computers. In such cases, provisioning a computer for an execution requires presentation of the “platform” key.) As an example, a policy may require that a particular data asset can only be processed on a certain computer or a computer that is provisioned (from a cloud provider) within a certain jurisdiction.

Yet another type of policy involves revocation of a previously authorized policy. This may be thought of as a “meta” policy in the sense that it relates to policies whereas previously discussed policies relate to assets.

The implementation of the policies described above may be based on controlling the provisioning of keys from key manager 663 (cf. FIG. 7C) to a secure environment, e.g., computing environment 631 (FIG. 7C). Recall that secure environments need decryption keys to decrypt an asset before use. Thus, by controlling the provisioning of (decryption) keys, we may enable/disable access to one or more assets.

Metering Based on Operations Within Secure Environments

A central aspect of the policy control of the execution and provisioning of assets concerns charging for those assets.

In some embodiments, one set of charging mechanisms may be based on asset owners assigning prices to their assets or asset users offering pricing for a given asset. Such schemes may be considered as part of “out of band” negotiations between owners and users of assets.

We now present a charging mechanism that is intimately tied to the sharing fabric proposed in the present invention. In this mechanism, we observe that secure environments containing assets may need to encrypt and decrypt those assets. Encryption and decryption of assets is a central and important service provided by secure environments.

It is proposed that in some embodiments secure environments may be provisioned with computer programs that track the number of encryption and decryption actions performed to service a given sharing action. For example, an output receiver may use the catalog of shared assets (described above) to discover a programmatic asset and a dataset asset. It may then stitch the two assets together and launch a computation to be executed on a given data plane, with the output directed to itself.

It is to be observed that to carry out the about directive, the computation may need to decrypt the programmatic and data assets, encrypt the output, etc.

We may now define a charge for the computation as a function of the number of encrypt/decrypt operations. We observe that in this view, a secure computing environment may be thought of as a “meter” that tracks the number of encrypt/decrypt operations.

The fact that the encrypt/decrypt operations occur within a secure environment, and the program tracking such operations runs inside the secure environment, implies that the operations and their tracking can be trusted. That is, secure environments may be thought of as housing or providing trusted metering devices.

In implementations or arrangements wherein a multiplicity of secure environments is statically provisioned, e.g., in a cluster of computers, or dynamically provisioned, e.g., to effectuate a launched computation, the metering can be made more efficient as follows.

FIG. 7C shows secure supervisory or controlling computing environment 661 containing Controller 662 which, in turn, contains Key Manager 663. Key Manager 663 provides keys to various secure computing environments such as secure computing environments 621, 631 and 641. Thus, secure controlling computing environment 661 may be thought of as a “primary environment” causing keys to be provided to other secure environments. By the same token, computing environments 621, 631 and 641 may be thought of as “secondary” environments.

Further note that secure computing environments 621, 631 and 641, when first created need to be authenticated by secure supervisory or controlling computing environment 661 before keys can be provisioned to them (cf. step 5, FIG. 6B), i.e., before they can request and receive keys, and before they may be provisioned with assets. Thus, secondary environments are authenticated by the primary environment.

In some embodiments, that primary computing environments may be configured to enable metering whereas secondary computing environments track the encrypt/decrypt operations and send the corresponding tabulations to the primary environment.

In one particular implementation, consider FIG. 7E. Computer program Federation Manager 7E10 may be configured to effectuate metering, receiving tabulated counts of encrypt/decrypt operations from Fed Agent programs 7E11, 7E12 and 7E13 located in secure computing environments of organizations A, B and C, respectively.

Practical Considerations for a Service Provider

FIG. 7E shows one particular embodiment of the more generalized case shown in FIG. 7C. This embodiment is directed to Internet-based Cloud Computing environments.

In FIG. 7E the program and data provider, and output receiver roles are provided by member organizations A, B and C respectively. The role of the service provider providing the supervisory or controlling computing environment is performed by the Federation Service Provider. The term “federation” denotes the extent of the sharing relationship, i.e., the control and data planes of FIG. 7C extend to cover the cloud accounts of organizations A, B and C. Each individual cloud account contains storage nodes, container registries (which may be thought of as storage abstractions for computer programs), and vault systems (or API to vault systems) for storing of credentials. For simplicity FIG. 7E does not show the inter-connections between the various nodes that exist within each of the organization cloud accounts.

Additionally, a sharing server node and (Federation) Agent node exists to receive sharing commands and actions and maintain consistency of information between the various cloud accounts. The Sharing Server acts as a proxy for the sharing service.

Note that a data plane exists between the secure environments of each account and that each account receives control information (e.g., keys) from the Federation Service Provider.

It is to be noted further that each cloud account may exist on distinct cloud providers, e.g., Organization A's account may exist on cloud provider 1 and Organization B's account may exist on cloud provider 2, etc.

Whilst FIG. 7E shows an embodiment employing multiple public cloud accounts, other embodiments may involve private clouds, private networks and data centers, and/or combinations thereof.

### ILLUSTRATIVE EMBODIMENTS

To reify the above descriptions without loss of generality, we consider various illustrative embodiments.

### Illustrative Embodiment 1 (Multiparty Transaction)

As background to a first illustrative embodiment, consider a first organization that wishes to perform predictive analytics on its proprietary data by using an algorithm provided by a second party. The first party would like to preserve the confidentiality of its dataset, whilst the second party wishes to protect the Intellectual Property of its algorithm (embodied in a computer program).

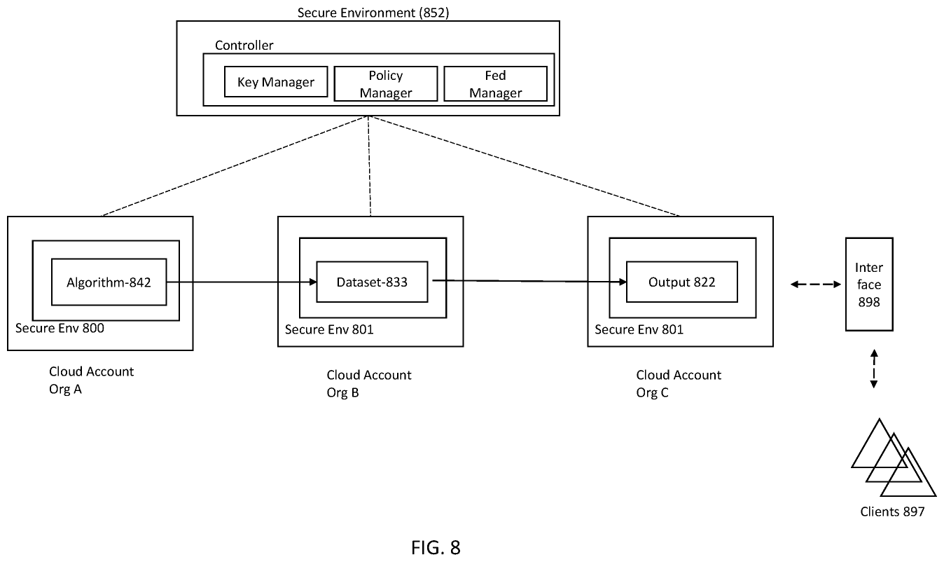

Thus, the envisaged transaction between the first and second party could be effectuated by a policy directed computation using secure environments as shown in FIG. 8, which is based on FIG. 7E.
FIG. 8 shows the supervisory secure computing environment 853 of the service provider (or operator of the service). FIG. 8 also shows secure computing environments of three organizations A, B and C playing the roles of program provider, data provider and output receiver, respectively. Organizations B & C are assumed to be the same organization playing two different roles.
Cloud account A belongs to the program provider. Algorithm/program 842 may be an algorithm, for example, designed to generate predictive analytics from input data. The algorithm is secured by in secure computing environment 800 and may be stored in encrypted form in a storage system of cloud account A (not shown in FIG. 8). Algorithm 842 may be provided to another secure computing environment 801, but, since it is encrypted, a decryption key will be needed by the receiving environment which it can request from the controller in secure computing environment 852.
Cloud account B belongs to the dataset provider/owner. Secure computing environment 801 may receive algorithm/program 842 and its decryption key (from the controller contained in computing environment 852) and invoke the computation involving program 842 and dataset 833.
Cloud account C belongs to the output receiver who expects to be provided the outputted results from the execution of program 842 on dataset 833. The output results 822 will be encrypted and contained within secure computing environment 802. Thus, a decryption key will need to be provided by the controller in secure computing environment 852.
Cloud account C has an interface 898 to a collection of clients 897, e.g., web client technology may be used to enable 897 if, for instance, interface 898 uses https protocol.

Preferentially, algorithm provider and dataset provider use out-of-band channels to reach an agreement whereby algorithm/program 842 is provided to secure computing environment 801, where it may be used to obtain predictive analytics from dataset 833. Once the processing is completed, the results may be provided to the output receiver who may then use web clients 897 to query the results.

As an alternative or support to the out-of-band arrangements, the federation service provider may provide a catalog service and make it available to all member organizations, i.e., their cloud accounts. Such a service may list all available programs and datasets (along with their concomitant policies) that have been “published” by the members for purposes of sharing. The catalog may thus be searched (“browsed”) and programmatic and data assets may be discovered and “stitched” together, along with their constituent policies, into executable computations in secure environments.

We note that in the arrangement shown in FIG. 8 the dataset owner retains ownership of the dataset 833. We further note, as described above, that the dataset owner does not have access to the program 842, which is only decrypted inside secure computing environment 801. Thus, the basic policies controlling the intended transaction between the algorithm and data providers are maintained.

We also note that the output receiver does not have access to dataset 833 or program 842.

We further note that the provisioning of the output receiver with encrypted results is optional. In some embodiments, the results may be provisioned in cleartext.

### Illustrative Embodiment 2 (Customizing Datasets)

There is a general practice in the data markets of today to prepare healthcare datasets by de-identifying them of patient information and provide the resulting datasets on commercial basis to interested enterprises. For example, pharmaceutical companies are often interested in de-identified datasets for research and development purposes.

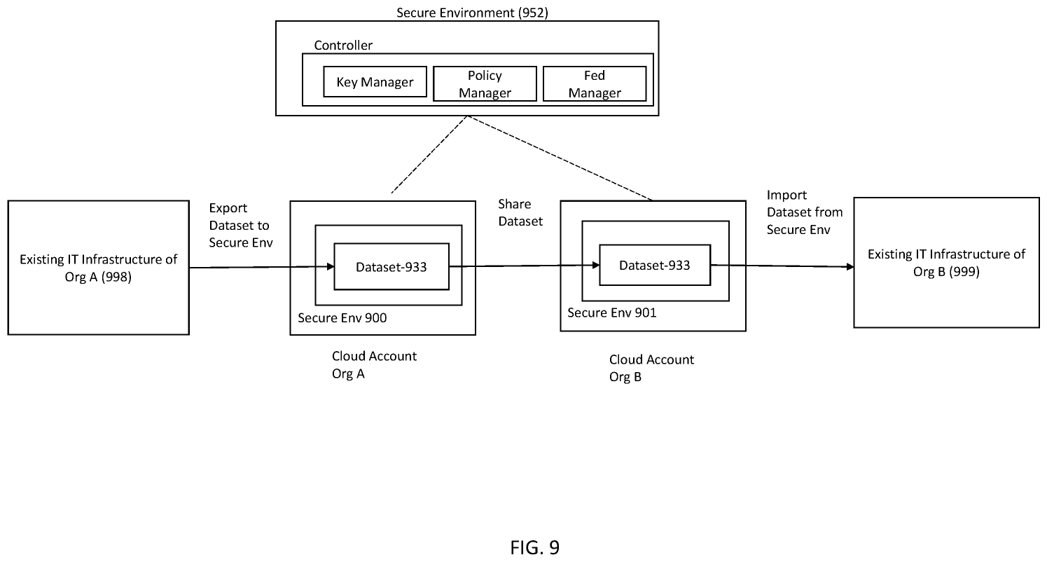

We explain this illustrative embodiment with respect to FIG. 9.

Organization A (FIG. 9) uses its existing IT infrastructure 998 to create and export a dataset 933 to its cloud account containing secure computing environment 900.

Next, organization A shares dataset 933 with the cloud account of organization B containing secure computing environment 901. Dataset 933 is registered in the sharing catalog and becomes visible to members of the sharing federation.

Organization B uses its existing IT infrastructure 999 to import/pull Dataset 933 from its secure computing environment 901. It may now process Dataset 933.

Additionally, since Dataset 933 has been provided by organization A to organization B, a sharing policy may have been imposed by organization A restricting the processing of Dataset 933 by a pre-determined and designated application, identified by its hash digest (as explained above). The designated application would then be required to run in secure computing environment 901. Audit logs may be generated showing that the only application accessing Dataset 933 was the application uniquely identified by its digest.

In an extension of the above use case, organization B may wish to provide an algorithm, say ABC, to organization A and request A to use ABC to construct a new version of Dataset 833, i.e., a customized dataset. To effectuate this variation of the use case, we may proceed as follows.

Organization B publishes algorithm ABC into its cloud account containing secure computing environment 933 and shares it with organization A. Algorithm ABC becomes available to organization A in A's secure environment 900.

Organization A pulls/pushes other assets into its IT infrastructure as needed to create a customized dataset which it may now share with organization B. Note that “pull,” “push,”, “import,” and “export” are well-known terms of art.

Also note that since algorithm ABC is provided to organization A through a secure sharing process which encrypts the contents of ABC, organization A is unable to access the contents of ABC.

### Illustrative Embodiment 3 (Software as a Medical Device)

In Machine Learning (ML) technology, inputted datasets, called training datasets, are used by computer programs to produce a new type of computer program called a model. The internal memory state of the model is said to represent the learnings obtained through the processing of the training sets. At the conclusion of the training, a model is said to be trained and this phase is called the training phase.

Once trained, a model may be used to process actual data. For example, we may use a model trained for detecting pulmonary hypertension from ECG data, or a model for deciding the approval or disapproval of a credit loan application from an applicant's loan request data. This phase is called the serving phase.

Additionally, a trained model, when deployed in the field, may gather and save data related to its performance (e.g., percentage of correct diagnoses) etc. Such data may then be used to retrain the model to improve its performance. This phase is called the retraining phase.

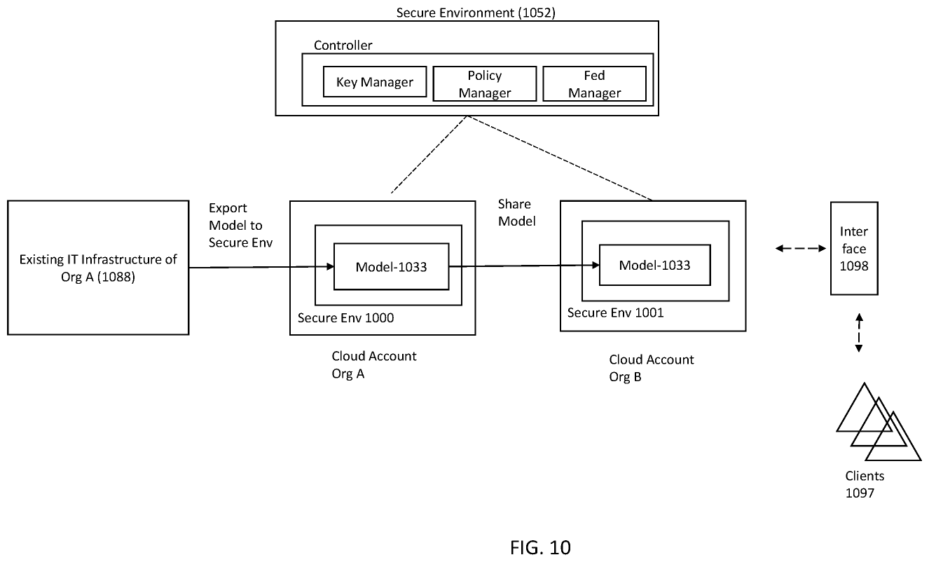

FIG. 10 shows an illustrative embodiment. Organization A uses its existing IT infrastructure to train model 1033 and then exports/publishes it to a secure computing environment 1000 in its cloud account. It may share (via policies) model 1033 with organization B which may pull/import shared model 1033 into its secure environment 1001.

Model 1033 may now be used in its serving phase wherein model 1033 may be accessed via interface 1098 by various clients 1097. That is, model 1033 is configured to provide outputs to queries inputted from clients 1097.

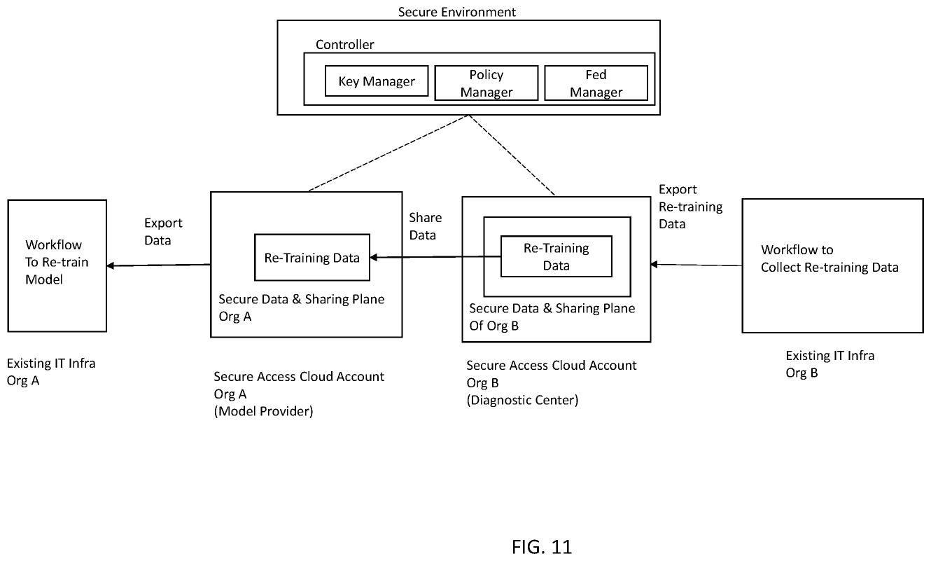

Model 1033 may be further configured to produce a second set of outputs, the so-called retraining sets, designated to be shared with organization A (See FIG. 11). That is, the retraining sets are encrypted with the decryption key being held by organization A.

We thus see that
a) Model 1033 is encrypted and thus its IP is protected in the field.
b) The integrity of Model 1033 may be trusted (and hence its results as being unaffected by intrusive software) since it only executes inside a secure environment, i.e., an isolated and protected environment.
c) The retraining dataset is only available to the original model owners and is thus confidential.

In many instances in the above descriptions, a symmetric key may need to be communicated by one entity to another entity, e.g., the Controller may need to communicate a symmetric key to the output receiver. In some embodiments, symmetric keys may be encrypted using a public key for purposes of protecting the symmetric key during communication. (This is in addition to using a secure communication channel.) The following method explains such use cases.

Method: Use Public Key to Encrypt Symmetric Key
Initially, Controller is executing in a secure computing environment and has received a public key from Output Receiver (in an out of band communication).
Controller generates symmetric key.
Controller encrypts symmetric key using the Output Receiver's public key.
Controller communicates the encrypted symmetric key to the Output Receiver.
Output Receiver uses the private key to decrypt the received encrypted symmetric key.

Similarly, there may be a need to communicate a public key securely between two entities and we may use a previously known symmetric key (e.g., using an out of band communication) to encrypt the public key that is to be communicated. Illustrative

Computing Environment

As discussed above, aspects of the subject matter described herein may be described in the general context of computer-executable instructions, such as computer programs, being executed by a computer or a cluster of computers. Generally, computer programs include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

As used herein the terms “software,” computer programs,” “programs,” “computer code” and the like refer to a set of program instructions running on an arithmetical processing device such as a microprocessor or DSP chip, or as a set of logic operations implemented in circuitry such as a field-programmable gate array (FPGA) or in a semicustom or custom VLSI integrated circuit. That is, all such references to “software,” computer programs,” “programs,” “computer code,” as well as references to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A method for securely receiving an algorithm in a computing environment that is to process a dataset, comprising:
receiving in a first trusted and isolated computing environment an algorithm for processing datasets that is received in encrypted form from an algorithm-providing computational domain of an entity that is authorized to provide the algorithm, the algorithm being encrypted by a first encryption key, wherein the first trusted and isolated computing environment is established by a controlling trusted and isolated computing environment that provides the algorithm-providing computational domain with a second encryption key for encrypting the first encryption key; and
receiving in the first trusted and isolated computing environment from the controlling trusted and isolated computing environment a first decryption key for decrypting the first encryption key such that the first trusted and isolated computing environment is able to decrypt the encrypted algorithm without allowing any other computational domain to access the algorithm in an unencrypted form except for the algorithm-providing computational domain, wherein a trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate.

2. The method of claim 1 wherein the first encryption key is a symmetric key.

3. The method of claim 2 wherein the symmetric key is generated within the algorithm-providing computational domain.

4. The method of claim 3 wherein the symmetric key is encrypted by the second encryption key within the algorithm-providing computational domain and provided to the controlling trusted and isolated computing environment.

5. The method of claim 4 further comprising:
receiving in the first trusted and isolated computing environment from the controlling trusted and isolated computing environment a decryption key for decrypting the symmetric key;
decrypting the encrypted algorithm within the first trusted and isolated computing environment to provide an unencrypted algorithm;
re-encrypting the unencrypted algorithm with a second encryption key received from the controlling trusted and isolated computing environment; and
storing the re-encrypted algorithm in a storage system external to the first trusted and isolated computing environment.

6. A method of securely processing a dataset with an algorithm to produce an output result to be securely provided to an output recipient, comprising:
establishing, with a controlling trusted and isolated computing environment, a first trusted and isolated computing environment in which a dataset to be processed by an algorithm is received in encrypted form from a dataset-providing computational domain of an entity that is authorized to provide the dataset, the dataset being encrypted by a first encryption key, the controlling trusted and isolated computing environment providing the dataset-providing computational domain with a second encryption key for encrypting the first encryption key;
providing to the first trusted and isolated computing environment, from the controlling trusted and isolated computing environment, a first decryption key for decrypting the first encryption key such that the first trusted and isolated computing environment is able to decrypt the encrypted dataset without allowing any other computational domain to access the dataset in an unencrypted form except for the dataset-providing computational domain, wherein a trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate;
wherein the first trusted and isolated computing environment obtains the algorithm that is to process the dataset by receiving the algorithm as an encrypted algorithm from an external storage system and decrypts the encrypted algorithm using a second decryption key obtained from the controlling trusted and isolated computing environment such that the first trusted and isolated computing environment is able to decrypt the encrypted algorithm without allowing any other computational domain to access the algorithm in an unencrypted form except for the computational domain of an entity that is authorized to provide the algorithm; and
causing the algorithm to process the dataset in the first trusted and isolated computing environment to produce an output result.

7. The method of claim 6 wherein the first encryption key is a symmetric key.

8. The method of claim 7 wherein the symmetric key is generated within the dataset-providing computational domain.

9. The method of claim 8 wherein the symmetric key is encrypted by the second encryption key within the dataset-providing computational domain and provided to the controlling trusted and isolated computing environment.

10. The method of claim 6 further comprising:
providing from the controlling trusted and isolated computing environment to a designated recipient of the output result a second encryption key for encrypting a symmetric key provided to the designated recipient by the dataset-providing computational domain;
receiving in the first trusted and isolated computing environment the encrypted symmetric key from the designated recipient;
receiving a third decryption key in the first trusted and isolated computing environment from the controlling trusted and isolated computing environment for decrypting the encrypted symmetric key;
decrypting the encrypted symmetric key in the first trusted and isolated computing environment using the third decryption key; and
encrypting the output result in the first trusted and isolated computing environment using the symmetric key and storing the encrypted output result in a storage system external to the first trusted and isolated computing environment and the controlling trusted and isolated computing environment.

11. A method for securely receiving a dataset in a computing environment that is to process the dataset, comprising:
receiving in a first trusted and isolated computing environment an encrypted dataset from a dataset-providing computational domain of an entity that is authorized to provide the dataset, wherein the encrypted dataset is only able to be decrypted in the first trusted and isolated computing environment using decryption keys available from the dataset-providing computational domain and a controlling trusted and isolated computing environment that generates the first trusted and isolated computing environment, wherein a trusted and isolated computing environment is a computing environment whose computer code is able to be attested by comparing a digest of the computing environment to a baseline digest of the computing environment that is available to third parties to thereby verify computing environment integrity while also being a computing environment in which only a specified maximum number of application processes and specified system processes implementing the computing environment are able to operate; and
decrypting the encrypted dataset in the first trusted and isolated computing environment using the decryption keys such that the decrypted dataset cannot be accessed in an unencrypted form by any computational domain except for the computational domain of the entity that is authorized to provide the algorithm.

12. The method of claim 11 wherein one of the decryption keys is a symmetric key received in the first trusted and isolated computing environment in an encrypted form and generated by the dataset-providing computational domain.

13. The method of claim 12 wherein a second of the decryption keys is received in the first trusted and isolated computing environment from the controlling computational domain, wherein the second decryption key is configured to decrypt the symmetric key.
